(19) United States
(12) Patent Application Publication
(10) Pub. No.: US 2015/0089779 A1
(43) Pub. Date: Apr. 2, 2015

(54) CLOSURE DEVICES FOR COUPLING COMPONENTS TO RACKS AND METHODS THEREFOR

(71) Applicant: Boa Technology Inc., Denver, CO (US)

(72) Inventors: Patrick Lawrence, Denver, CO (US); Robert Burns, Denver, CO (US); Noah Schum, Denver, CO (US); Michael Nickel, Golden, CO (US); Clark Morgan, Denver, CO (US); Daniel McGlynn, Denver, CO (US); Aaron Venturini, Denver, CO (US)

(21) Appl. No.: 14/489,821

(22) Filed: Sep. 18, 2014

Related U.S. Application Data
(60) Provisional application No. 61/879,577, filed on Sep. 18, 2013.

(51) Int. Cl. B60R 9/048; F16B 2/08; F16B 7/04

(52) U.S. Cl. CPC B60R 9/048; F16B 7/04; F16B 2/08
USPC 24/68 BT; 29/428

(57) ABSTRACT

A device for coupling a component to a rack includes a main body, a tension member, and a tightening mechanism. The main body includes a proximal end and a distal end that is releasably coupled with the proximal end. The main body is positionable around a body portion of the rack and the distal end is coupleable with the proximal end to secure the main body to the body portion of the rack. The tension member is attached to the main body, the proximal end, and/or the distal end of the device. The tightening mechanism is operably coupled with the tension member and configured to tension the tension member to shorten a longitudinal length of the main body and thereby constrict the main body about the rack to firmly secure the device to the rack.

### CROSS-REFERENCES TO RELATED APPLICATIONS

This application claims priority to U.S. Patent Application No. 61/879,577 filed Sep. 18, 2013, and titled “Closure Devices for Coupling Components to Racks and Methods Therefor,” the entire disclosure of which is hereby incorporated by reference, for all purposes, as if fully set forth herein.

### BACKGROUND OF THE INVENTION

The embodiments described herein are related to closure devices for coupling components to various racks, such as vehicle roof racks and the like. The components that may be coupled or attached to such racks include bicycles, fishing gear, camping hear, climbing gear, outdoor gear, small furniture, and the like. These components or items are often coupled with a roof rack to transport the components or items between locations, such as from a home to a destination (e.g., ski area, camping area, new home, and the like). Conventional devices for attaching such components or items to a roof's rack are often tedious and time consuming to use, thereby frustrating a user and/or resulting in incorrectly coupling of said devices. Accordingly, more convenient ways to attach components or items to a roof are desired.

### BRIEF SUMMARY OF THE INVENTION

The embodiments described herein provide closure devices for coupling or attaching components to a rack. According to one aspect, a device for coupling a component to a rack includes a proximal end and a distal end that is releasably coupled with the proximal end. The main body is positionable around a body portion of the rack and the distal end is coupleable with the proximal end to secure the main body to the body portion of the rack. The tension member is attached to the main body, the proximal end, and/or the distal end of the device. The tightening mechanism is operably coupled with the tension member and configured to tension the tension member to shorten a longitudinal length of the main body and thereby constrict the main body about the rack to firmly secure the device to the rack.

In some embodiments, the main body includes a corrugated inner surface that facilitates in positioning the main body around the body portion of the rack and/or the main body includes a softened or compressible inner surface that compresses against the body portion of the rack as the main body is constricted about the rack. In some embodiments, the proximal end includes a male coupling component and the distal end includes a female coupling component. In such embodiments, the tightening mechanism may be coupled with the proximal end. In some embodiments, the device includes a second body that is attached to the main body and releasably attachable around the component to be coupled with the rack.

According to another aspect, a method of coupling a device to a rack is provided. The device is configured for attaching a component to the rack and the method includes providing a device that includes: a main body having a proximal end and a distal end, a tension member attached to the main body, the proximal end, or the distal end of the device, and a tightening mechanism that is operably coupled with the tension member and configured to tension the tension member. The method also includes positioning the main body around a body portion of the rack and coupling the proximal end with the distal end to secure the main body to the body portion of the rack. The method further includes tensioning the tension member, via the tightening mechanism, to shorten a longitudinal length of the main body and thereby constrict the main body about the rack to firmly secure the device to the rack.

In some embodiments, the main body includes a corrugated inner surface that facilitates in positioning the main body around the body portion of the rack and/or the main body includes a softened or compressible inner surface that compresses against the body portion of the rack as the main body is constricted about the rack. In some embodiments, the proximal end includes a male coupling component and the distal end includes a female coupling component. In such embodiments, the tightening mechanism may be coupled with the proximal end. In some embodiments, the device includes a second body that is attached to the main body and releasably attachable around the component to be coupled with the rack.

### BRIEF DESCRIPTION OF THE DRAWINGS

The present invention is described in conjunction with the appended figures:

FIG. 1 illustrates an embodiment of an attachment device that is positionable and coupleable around a rack that is attached to a roof of a vehicle or other object.

FIG. 2 illustrates an embodiment of an attachment device that is coupleable with a frame of a bicycle.

FIG. 3 illustrates another embodiment of an attachment device that may be used to attach one or more objects with a rack of a vehicle or other object.

FIG. 4 illustrates a device for securing a bicycle tire to a rack of a car or other object.

FIGS. 5A-B illustrate embodiments of devices that quickly and easily couple objects with a rack.

FIG. 6 illustrates an embodiment of a device that may be used to secure a bicycle atop a vehicle.

FIG. 7 illustrates a removable roof rack that may be removably attached to a vehicle.

FIG. 8 illustrates a rack that may be removably attached to a roof rack of the vehicle.

FIG. 9 illustrates an embodiment of a bag or pouch that may be attached to a bicycle or other vehicle to transport one or more items.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The embodiments described herein provide devices and mechanisms that are attachable to racks for various reasons. Racks are often used as attachment or securing members for various items. For example, roof racks are commonly attached to the top of automobiles to allow an individual transport items that are attached to the roof rack. Some vehicles include rear mounted racks, such as hatchbacks and the like. The items that may be attached to the roof rack include luggage or cargo bags, bicyclyes, skis, snowboards, fishing equipment, camping equipment, hardware, furniture, and the like. Attachment devices are typically used to attach these items to the vehicle's roof. For example, straps or rope are often threaded around and between roof rack members to attach luggage or furniture to the top of vehicle.

Conventional attachment devices, however, are often difficult to use and/or time consuming to attach and detach from the vehicle's roof rack. As such, individuals that are attaching items to the vehicle's roof often waste a considerable amount of time in securing items to the vehicle's roof and/or removing items therefrom. Further, the attachment devices may be difficult or cumbersome to use, which may frustrate the individual. In some instances, if the attachment device is overly burdensome to use, the individual may attempt to shortcut the attachment process, which may result in an item being improperly secured to the vehicle. In such instances, operation of the vehicle may be dangerous as the improperly attached item may fall off the vehicle while the vehicle is in motion.

In some instances the roof rack may be removable from the vehicle. Removable roof racks allow an individual to attach the rack when needed and allow the individual to remove the rack when the rack is not being used. Such removable racks may enhance the look or appeal of the vehicle since components are not permanently attached to the vehicle's roof. Conventional removable roof racks are often difficult or cumbersome to use, however, because they require the individual to sequentially tighten or tension opposing sides of the removable rack. For example, users are often required to tension one side of the removable rack about the vehicle and then walk around the car to tension the opposite side of the removable rack. Several iterations of this process are typically required to ensure that the removable rack is properly and evenly tensioned about the car. This process is typically tedious and overly time consuming.

In other embodiments, racks may be used for different purposes. For example, racks are often used in homes for storage purposes. In such instances, home owners may place and/or attach items to the rack for long or short term storage of the items. Racks are similarly used in boats, campers, recreational vehicles, bicycles, storage units, department or other stores, and the like. The embodiments described herein provide devices and mechanisms that may easily and quickly attach and detach from such racks. The embodiments may also couple or secure with items that are to be mounted or attached to the racks. In some embodiments, the devices or mechanisms may be used to quickly and conveniently attach removable racks to a vehicle, bicycle, recreational vehicle, or other object.

The speed and convenience of attaching the devices described herein to a rack is mainly provided by using an adjustable reel or lacing system (hereinafter reel system). The reel systems typically include a reel assembly having a knob that may be grasped and rotated by a user to wind lace about a spool or unwind lace therefrom. As the lace is wound about the spool, the attachment device may be incrementally tightened/tensioned or loosened. In some embodiments, the lace may pull on straps or other components of the attachment device to enable tightening/tensioning of the device. Exemplary embodiments of lacing systems are described in the following U.S. Patent Applications, the entire disclosures of which are incorporated by reference herein: U.S. patent applications Ser. No. 13/343,658, filed Jan. 4, 2012, entitled “Reel Based Closure System,” U.S. patent applications Ser. No. 13/273,060, filed Oct. 13, 2011, entitled “Reel-Based Lacing System,” and U.S. patent applications Ser. No. 13/098,276, filed Apr. 29, 2011, entitled “Reel Based Lacing System.”

One advantage among many of the devices described herein is in the use of lace based systems. The lace based systems provide attachment devices that are conformable to virtually any rack system. Stated differently, the lace based systems may easily adapted to the rack of virtually any vehicle regardless of whether the rack is factory or custom installed. Further, a single lace based attachment device or system can be used for multiple different shaped crossbars/rack systems due to the conformability provided by such devices/systems.

For convenience in describing the embodiments, the roof racks described herein will be mainly described as being attached or secured to an automobile or car. It should be realized, however, that the racks may be attached essentially to any object, or used with stand alone racks, and/or coupled or secured to essentially any rack. Having described several features of the attachment devices generally, additional features and aspects of the attachment devices will become evident in view of the description of the several drawings hereinbelow.

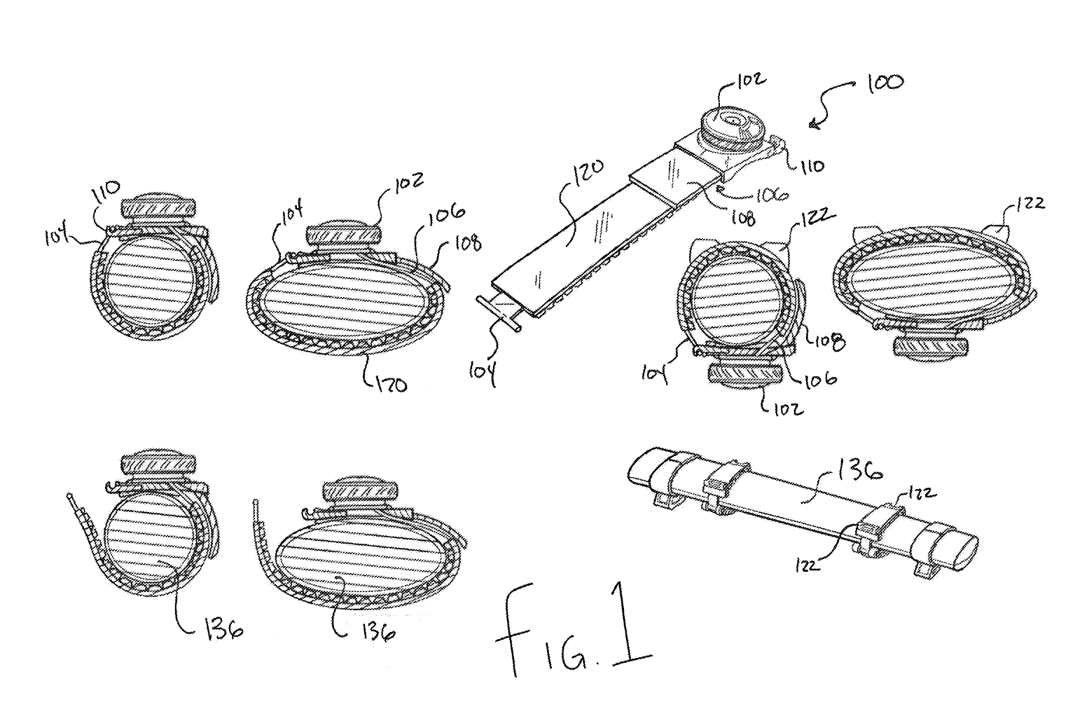

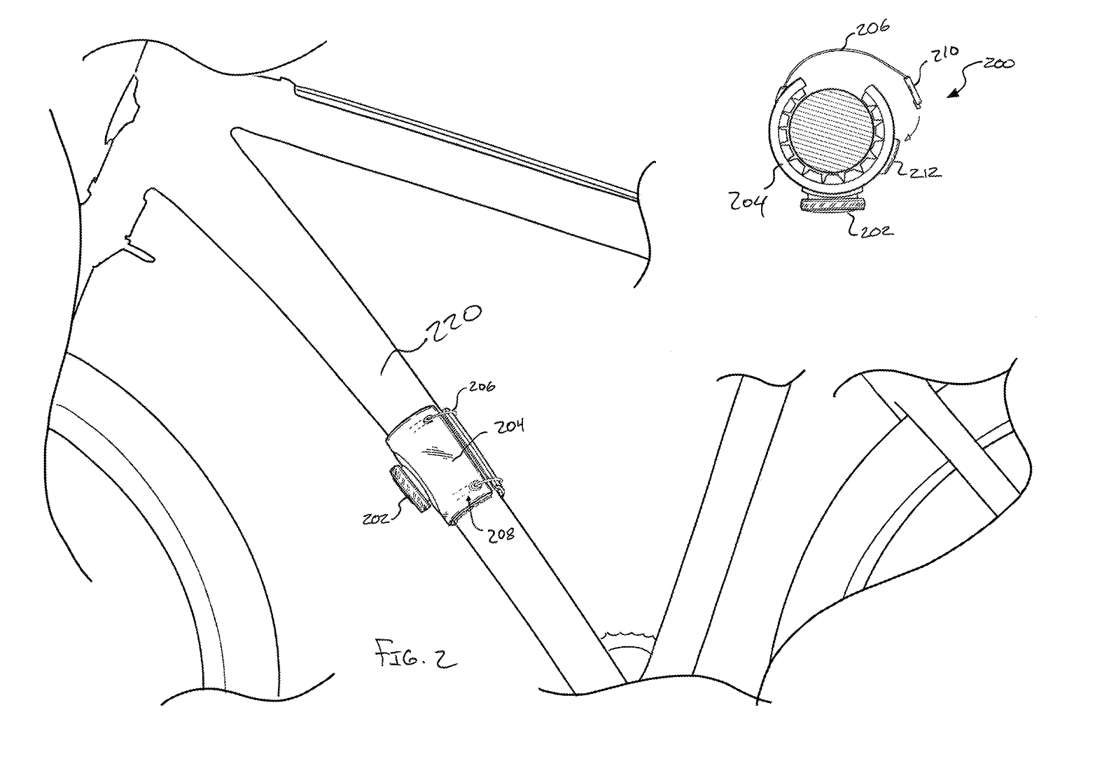

Referring now to FIG. 1, illustrated is an embodiment of an attachment device 100 that is positionable and coupled around a rack 136 attached to a roof of a vehicle or other object (not shown). Attachment device 100 includes a main body portion 120 having a proximal end and a distal end. A reel assembly 102, such as those described in the above incorporated U.S. patent applications, is coupled with the device 100 at a proximal end. An attachment mechanism 104 is attached to the device 100 at the distal end and is releasably coupleable with a coupling mechanism 110 on the proximal end of device 100. Attachment mechanism 104, in the illustrated embodiment, is a rod while coupling member 110 is a pair of hooked members. In use, the main body 120 of device 100 may be positioned around rack 136 and the attachment device 104 (e.g., rod) may be coupled with coupling device 110 (e.g., pair of hooks) to secure the device 100 around the rack 136.

In some embodiments, coupling device 110 may include multiple slots, or hook pairs, within which attachment device 104 may be positioned and secured. This configuration may allow the initial fit of main body 120 about rack 136 to be grossly or macro-adjusted. Further and fine-tune or micro-adjustment of the device 100 about rack 136 may then be achieved via operation of reel assembly 102.

The reel assembly 102 is coupled with lace 106 and further coupled with the proximal end of main body portion 120. Reel assembly 102 is operable to move the main body portion 120 longitudinally via lace 106. In this manner, device 100 may be positioned and secured around rack 136, and reel assembly 102 operated to tension the main body portion 120 about rack 136. A lace protection member or strap 108 is positioned over lace 106 between a base of reel assembly 102 and the main body portion 120. The protection member 108 covers lace 106 to prevent or limit exposure of the lace 106 to the outside environment. This may help protect the lace 106 from being damaged or broken. An inner surface of main body portion 120 that contacts rack 136 may be configured to contact and secure with rack 136 in a non-damaging manner. For example, the inner surface of main body portion 120 may include a relatively soft nondamaging rubber or other material that allows the main body portion 120 to securely grip rack 136 without scratching, scuffing, or otherwise damaging rack 136. The inner surface of main body portion 120 may also have a corrugated configuration that allows the main body portion 120 to be easily wrapped around rack 136.

As illustrated, device 100 may be attached with rack 136 so that the reel assembly 102 is positioned above rack 136 or below rack 136 as desired. The device 100 may be positioned about rack 136 so as to be easily accessible to the user and/or for any other reason. In some embodiments, device 100 may also include attachment components 122 that allow other objects or items (not shown) to be easily coupled with device 100. Attachment components 122 may include hooks, snaps, clasps, clamps, or any other mechanical fasteners known in the art. In such embodiments, device 100 may be quickly and easily attached with rack 136 and one or more other objects attached to device 100 via attachment components 122.

In use, the inner surface of main body portion 120 is positioned about rack 136 and the distal end of device 100 wrapped around rack 136 until attachment mechanism 104 is coupled with coupling mechanism 110. After the attachment mechanism 104 is coupled with coupling mechanism 110, reel assembly 102 is then operated to tension or tighten device 100 about rack 136. An object or item may then be coupled with device 100 via attachment components 122. With the item secured to device 100, the vehicle may then be driven to transport the item to a desired location. In other embodiments, an item may be secured with a rack via device 100 for short or long-term storage and the like. As illustrated in FIG. 1, device 100 is easily adaptable to various rack configurations. For example, device 100 easily fits around circular or oblong racks 136. The device 100 may also fit around various other odd shaped rack geometries, such as square racks and the like.

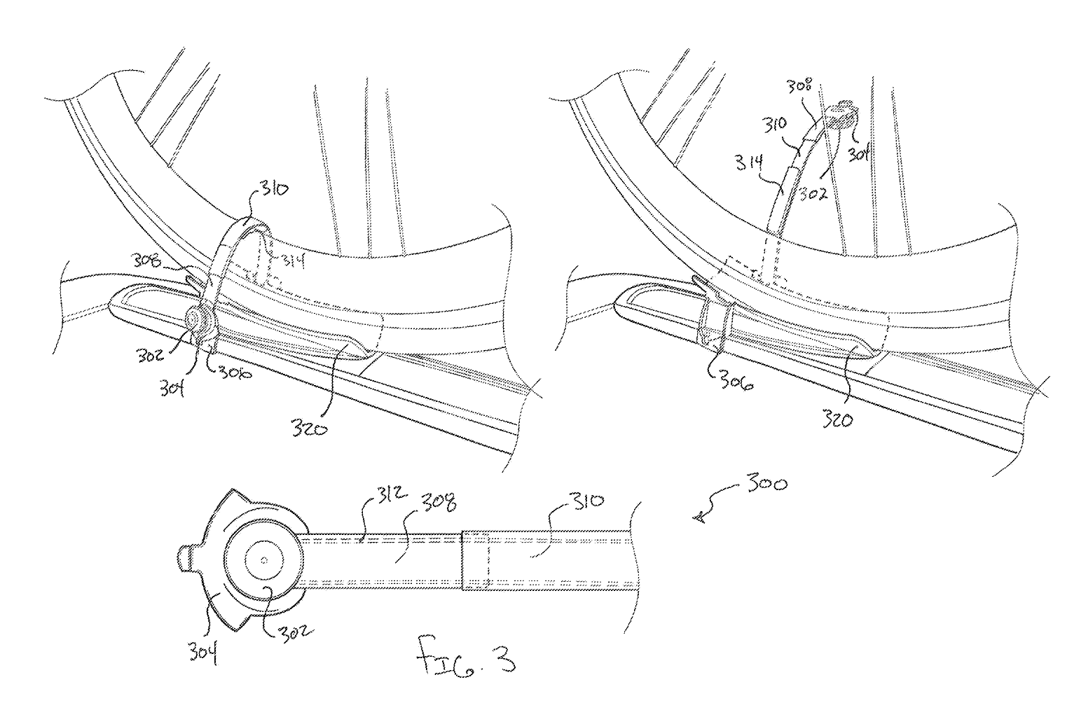

Referring now to FIG. 2, illustrated is an embodiment of an attachment device 200 that may be coupled with a frame 220 of a bicycle. Device 200 is similar to device 100 previously described in that device 200 includes a main body portion 204 that may be wrapped around the frame 220 of the bike. Device 200 is different from device 100 in that the reel assembly 202 is attached to a central portion of main body portion 204. Device 200 also includes a female coupling component 212 that is releasably couplable to male coupling component 210. When coupled together, the male coupling component 210 and female coupling component 212 may have a relatively thin and flat profile that provides a sleek appearance to device 200 and/or that reduces contact with surrounding objects. Exemplary embodiments of male coupling components 210 and female coupling components 212 are further described in U.S. patent application Ser. No. 14/071,435, filed Nov. 4, 2013, entitled “Coupling Members for Closure Devices and Methods,”the entire disclosure of which is incorporated by reference herein.

The male coupling component 210 is coupled at a proximal end with lace 206, which in turn is coupled with the reel assembly 202. The lace 206 may be disposed within main body portion 204 so as to be protected from the environment to prevent damage and/or breaking of the lace 206. In some embodiments, tubing 208 may be inserted within main body portion 204 and the lace 206 may be inserted through the tubing 208.

The male coupling component 210 allows the main body portion 204 to be easily placed about and wrapped around frame 220. The male coupling component 210 may then be quickly and easily coupled with female coupling component 212 to secure the main body portion 204 about frame 220. The reel assembly 202 may then be operated to tension the lace 206 and thereby tighten or tension device 200 about the frame 220. As with device 100, the inner surface of main body portion 204 may include a material that is capable of gripping about frame 220 without scratching, scuffing, or otherwise damaging the frame 220. The inner surface of main body portion 204 may also be corrugated to allow the main body portion 204 to easily wrap around frame 220. Although not shown, device 200 may also include coupling components that allow other objects or items to be easily coupled with device 200 so as to attach the objects or items (e.g., bags, water bottles, lights, pumps, and the like) to the frame 220 of the bike.

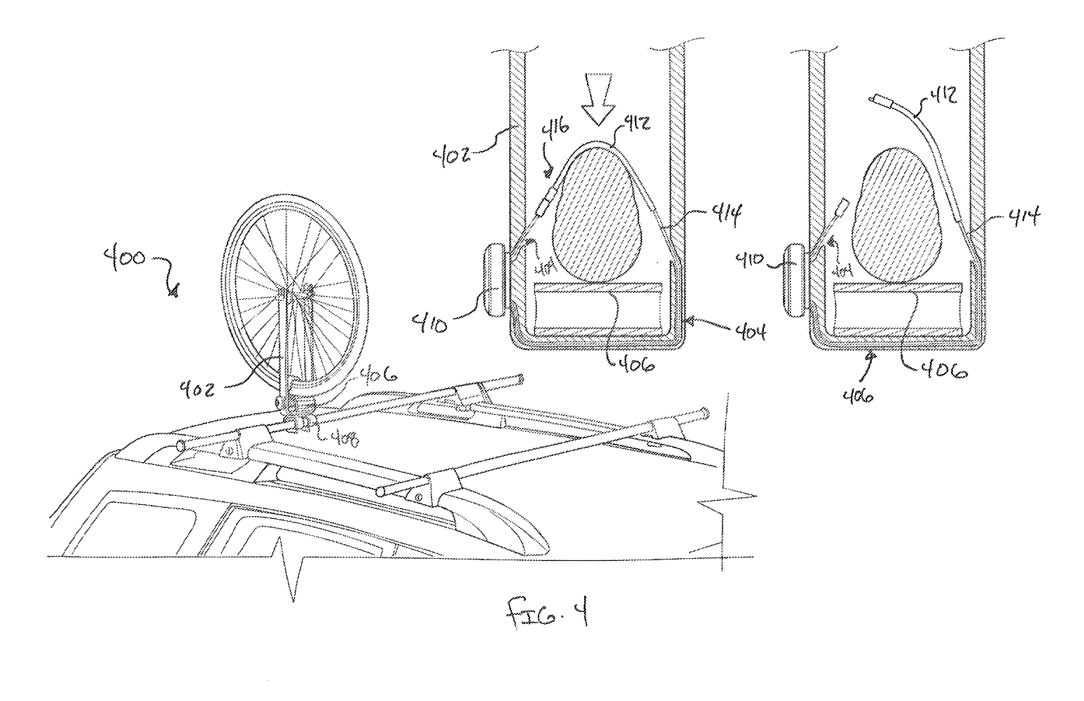

Referring now to FIG. 3, illustrated is another embodiment of an attachment device 300 that may be used to attach one or more objects with a rack of a vehicle or other object. Device 300 includes a first strap 308 and a second strap 310. A proximal end of the first strap 308 is slidably positioned within a lumen of the second strap 310. A reel assembly 302 is coupled with a distal end of the first strap 308. Lace 312 is coupled with the reel assembly 302 and is disposed within a lumen or channel of the first strap 308 and second strap 310. The reel assembly 302 is operable to tension the lace 312, which causes the first strap 308 to slide longitudinally within the lumen of second strap 310.

A proximal end of the second strap 310, and preferably the lace 312, is coupled with a base 320 of device 300. The reel assembly 302 is attached to a male coupling component 304, such as those described in the '435 Patent Application incorporated herein. The male coupling component 304 may be releasably coupled with a female coupling component 306 of base 320. In some embodiments, the reel assembly 302 may be attached to the base 320 at the proximal end of second strap 310 rather than coupling the reel assembly 302 with male coupling component 304. In such embodiments, the lace 312 may be disposed within the lumens of the first strap 308 and second strap 310 and coupled with male coupling component 304. One advantage, however, of coupling the reel assembly 302 with the male coupling component 304 is that the user may easily grasp the reel assembly 302 and use the reel assembly 320 in attaching the male coupling component 304 with the female coupling component 306. The user may then easily rotate the knob of reel assembly 302 to tighten or tension device 300. The user may easily perform this action process with one hand since the reel assembly 302 is coupled with the male coupling component 304.

As described briefly above, as the user operates reel assembly 302, the first strap 308 slides longitudinally within a lumen of second strap 310. With device 300 positioned around an object to be attached to the rack, the straps, 308 and 310, cinch down and around the object as the reel assembly 302 is operated to tension lace 312. The configurations of the straps, 308 and 310, and the lace 312 protect the lace 312 from exposure to the environment, which exposure could damage, fray, and/or break the lace 312. Because the lace 312 is protected from environmental conditions, the life the lace 312 and device 300 may be greatly extended.

In a specific embodiment, device 300 may be used to secure bicycle tires to the rack. In such an embodiment, base 320 may have an elongate U-shaped channel that is configured to accommodate the bicycle tire. The first and second straps, 308 and 310, may be wrapped around the bicycle tire and coupled with female component 306 to secure the bicycle tire atop the rack. The reel assembly 302 may then be operated to tighten or tension the lace 312 and thereby firmly secure the bicycle tire to the rack. In such embodiments, the inner surface of the second rack 310 may include padding 314 that is pressed against the bicycle tire as the reel assembly 302 is operated to tighten or tension the straps, 308 and 310, about the bicycle tire.

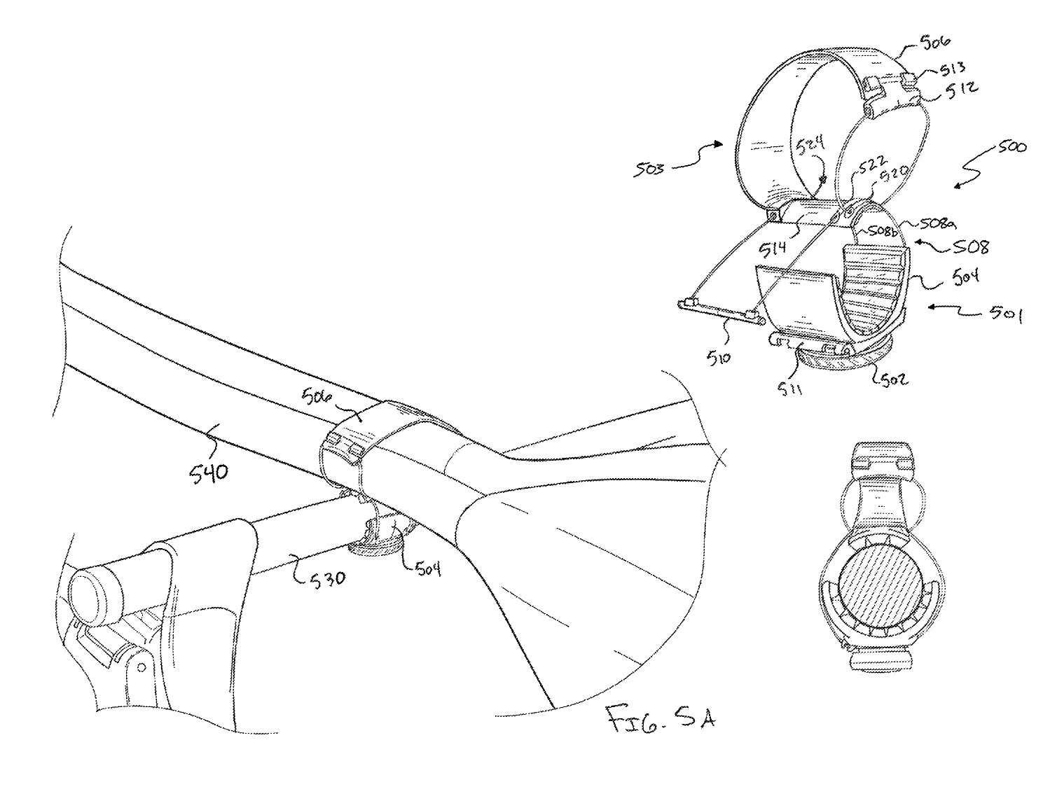

Referring now to FIG. 4, illustrated is a device 400 for securing a bicycle tire to a rack of a car or other object. Device 400 includes a fork mount 402 that releasably attaches to the bicycle tire. The fork mount 402 includes a pair of slots at a distal end that are similar to dropouts of a bike fork and within which the axle of the bicycle tire is positioned. A proximal end of the fork mount 402 includes an attachment device 408 that releasably attaches with the rack of the vehicle. The attachment device 408 may be similar to any of the attachment devices described herein or otherwise known in the art.

The fork mount 402 includes a reel assembly 410 that is operable to tension lace 414 and thereby secure a strap 412 that is positioned around the bicycle tire. The strap 412 may be positioned around the bicycle tire after the tire is inserted within the slots of fork mount 402. The strap 412 secures the bicycle tire within the fork mount 402 and atop a compressible component 406. The strap 412 may include male and female coupling components 416 as described herein and further described in the '435 Patent Application incorporated herein. The male and female coupling components 416 allow the strap 412 to be easily positioned and coupled around the bicycle tire.

With the strap 412 coupled around the bicycle tire, the reel assembly 410 may be operated to tension lace 414 and thereby secure the bicycle tire within the fork mount 402. In some embodiments, the lace 414 may be inserted within a lumen 404 of the body portion of fork mount 402. For example, a proximal U-shaped end of the fork mount 402 may include a lumen through which the lace 414 is positioned. The lace 414 is coupled with a proximal end of the strap 412 such that operation of the reel assembly 410 pulls or tensions the proximal end of the strap 412 downward relative to the fork mount 402 to secure the strap 412 around the bicycle tire. In some embodiments, securing the strap 412 about the bicycle tire may cause the compressible component 406 to flex or compress slightly downward relative to fork mount 402. Securing the bicycle tire via device 400 as described above prevents the bicycle tire from spinning within fork mount 402 as the bicycle tire is transported via the vehicle.

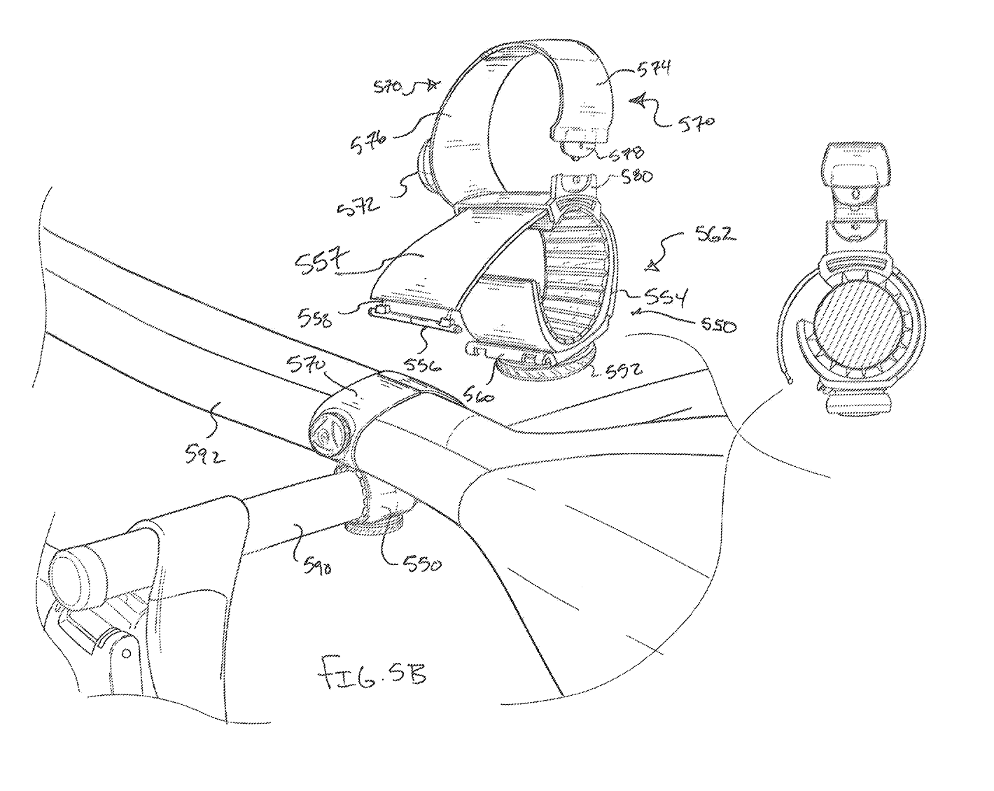

Referring now to FIGS. 5A-B, illustrated are embodiments of devices that quickly and easily couple objects with a rack. Specifically, FIG. 5A illustrates a device 500 that includes a first strap portion 501 that is positionable and securable around a rack 530 and includes a second strap portion 503 that is positionable and securable around an object to be secured or attached to the rack 530. In the illustrated embodiment, the object that is being secured to the rack 530 is an oar 540 of a kayak or canoe. The first strap portion 501 includes a main body 504 that is positionable around the rack 530. As described previously, an inner surface of the main body 504 that contacts the rack 530 may include a corrugated surface that is made of a grippable material that prevents scratching, scuffing, or other damage to rack 530. A reel assembly 502 is positioned relatively centrally about the main body portion 504 of the first strap 501, or elsewhere on the strap, and is operable to tension lace 508 as described herein. The lace 508 is attached to an attachment mechanism 510 (e.g., a rod) that is removably couplable with a coupling mechanism 511 (e.g., a pair of hooks or U-shaped channel) to secure the first strap 501 about the rack 530. A second body portion 514 is positioned along the path of lace 508 between opposing ends of main body 504. When coupled with rack 530, the second body portion 514 is positioned atop the rack 530 between the opposing ends of main body 504. The second body portion 514 may be slidable between the opposing ends of main body 504 and may prevent the lace 508 from contacting the rack 530, which may prevent or decrease wear of lace 508.

The second strap 503 also includes a main body 506 that may be wrapped around the object to be coupled or attached to rack 530, which in the illustrated embodiment is an oar 540. A proximal end of the main body 506 is attached to the second body portion 514 of first strap 501. The lace 508 is coupled with an attachment mechanism 512 (e.g., a rod) that in turn is releasably couplable with a coupling mechanism 513 (e.g., pair of hooks or U-shaped channel) of main body 506. The attachment mechanism 512 allows the main body 506 to be positioned around the object 540 and coupled with coupling mechanism 513 to secure the object 540 within the second strap 503. Although not shown, second strap 503 may also include a second body portion that is positioned along the path of lace 508 between a proximal and distal end of main body 506. The second strap 503 may also include a corrugated inner surface configuration that includes a grippable and/or soft material as described herein.

As shown in FIG. 5A, the first strap 501 and second strap 503 are tensioned or tightened via a single reel assembly 502. To enable tightening or tensioning of both the first strap 501 and second strap 503, a first lace 508a is inserted through a first tubing 520 of the second body 514, through a channel of attachment mechanism 512, through a second tubing 522 of the second body 514, and terminates at attachment mechanism 510. The first lace 508a forms a loop between the first tubing 520 and the second tubing 522. A second lace 508b is also coupled with attachment mechanism 510 and inserted through a third tubing 524 of second body 514. The reel assembly 502 is operated to tension the first and second laces, 508a and 508b, which simultaneously tensions or tightens the first strap 501 and second strap 503.

In some embodiments, the first lace 508a may be inserted through a lumen of attachment mechanism 510 and through the third tubing 524. In such an embodiment, the second lace 508b is not needed. An advantage of device 500 is that the single reel assembly 502 may be operated to simultaneously tension both the first strap 501 and the second strap 503 thereby allowing a user to easily and conveniently attach and firmly secure an object 540 to the rack 530.

FIG. 5B illustrates a similar embodiment of a device 562 that may be used to attach an object 592 (e.g., an oar) to a rack 590. Like device 500, device 562 includes a first strap 550 and a second strap 570. The first strap 550 includes a main body 554 that is positionable and securable around the rack 590. The first strap 550 includes an attachment mechanism 556 that is couplable with a coupling mechanism 560 as described herein. One of the differences between device 562 and device 500 is that a strap 557 is slidably disposed within a lumen of main body 554. The lace 558 extends from a distal portion of strap 557 and to attachment mechanism 556. Strap 557 covers and protects the lace 558 from exposure to the environment, which helps prevent the lace 558 from fraying, breaking, or other damage. As a user operates reel assembly 552, strap 557 slides within the lumen of main body 554 to tension or tighten the first strap 550 about rack 590.

The second strap 570 also includes a main body 576 and a strap portion 574 which is slidably disposed within or over main body 576. A proximal end of main body 576 is coupled with a distal end of main body 554 of first strap 550. A distal end of strap 574 includes a male coupling component 578 that is releasably couplable with a female coupling component 580 as described herein and further described in the '435 Patent Application. The female coupling component 580 is coupled with the distal end of main body 554 of first strap 550. The male and female coupling components, 578 and 580, allow the second strap 570 to be easily attached and detached from about object 592. Second strap 570 also includes a reel assembly 572 which is operable independent of reel assembly 552 to tension or tighten the second strap 570 about object 592. As reel assembly 572 is operated by a user, strap 574 slides within or about main body 576 as described herein. The lace (not shown) of reel assembly 572 is disposed within a lumen of main body 576 and strap 574, which covers and protects the lace from outside environmental conditions.

An advantage of device 562 is that the first strap 550 and second strap 570 may be independently tensioned or tightened. This allows a differential tension to be applied to both the first strap 550 and the second strap 570, which may be beneficial in instances where additional tension or tightness is needed in one of the straps, but not in the other strap. For example, if a relatively delicate item is being transported, far less tension may be needed in the second strap 570 than the first strap 550. An additional advantage of device 562 is in the use of slidable straps rather than exposed lace since the slidable straps cover and protect the lace from fraying and/or breakage. It should be realized that the slidable strap configuration can easily be applied to device 500 to provide the advantages described herein. Further, the devices of FIGS. 5A and/or 5B may also include the male and female coupling components rather than the attachment and coupling mechanisms to facilitate in coupling and decoupling the straps from the racks and other objects.

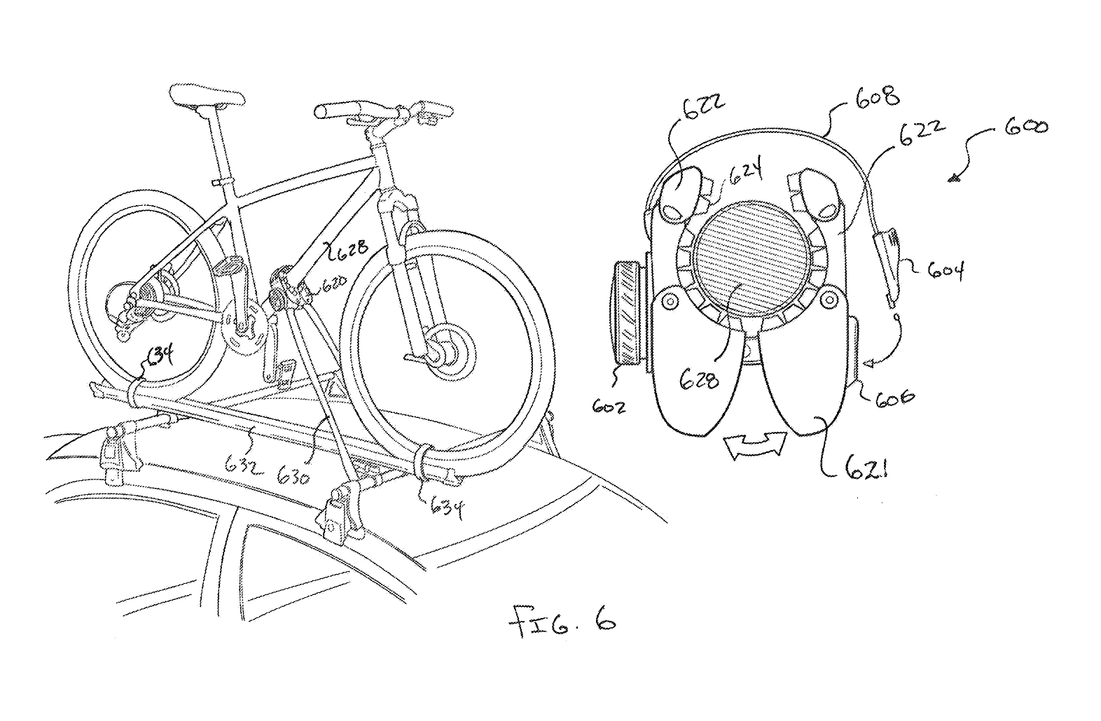

Referring now to FIG. 6, illustrated is an embodiment of a device 600 that may be used to secure a bicycle atop a vehicle. Device 600 includes a longitudinal U-shaped base member 632 within which the tires of the bicycle are positioned. The tires of the bicycle are secured to the base member 632 via straps or attachment devices 634. The attachment devices 634 may be similar to any of those previously described (e.g., device 300). The attachment devices 634 prevent the bicycle tires from rotating and also secures the bicycle tires to the base member 632. Base member 632 is attached to the vehicle's roof rack as illustrated. Device 600 also includes a pair of arms 630 that extend diagonally upward from the roof rack and that attach to the frame 628 of the bicycle. The pair of arms 630 attach to frame 628 via attachment device 620.

Attachment device 620 includes a main body 621 and a pair of side member 622 that are pivotally coupled with the main body 621. The side member 622 and main body 621 are positionable around the frame 628 of the bicycle and movable or pivotal radially inward so as to constrict against the frame 628. An inner surface of the main body 621 and side member 622 includes a corrugated grippable surface that presses against the frame 628 as described herein.

A reel assembly 602 is coupled with the main body 621. Reel assembly 602 is operable to tension a strap 608 that is positioned over an opening between side member 622. A distal end of the strap 608 is coupled with a male coupling component 604 that is removably attachable to a female coupling component 606 that is coupled with main body 621. The male coupling component 604 and female coupling components 606 may be similar to those described herein and further described in the '435 Patent Application. A proximal end of the strap 608 is coupled with lace (not shown) that is in turn coupled with reel assembly 602. In some embodiments, the lace (not shown) may be disposed within strap 608 and coupled with male coupling component 604 as described in some of the previous embodiments. As the lace and strap 608 are tensioned via reel assembly 602, the opposing side members 622 and main body 621 constrict about frame 628 to secure the bicycle to the top of the roof and within base member 632.

In another embodiment, reel assembly 602 may coupled with male coupling component 604, similar to the configuration of FIG. 3. In such embodiments, the user may grip reel assembly 602 and/or male coupling component 604 and couple the male component 604 with female component 606. The user may then operate reel assembly 602 to tension the device 600. The user may similarly loosen the device 600 and/or release the male component 604 from female component 6060. This configuration allows these actions to be performed with a single hand, which allows the user to grip the bicycle with one hand and secure and tension the device 600 about the bicycle with the other hand.

In operation, the frame 628 is inserted between the opposing side members 622 with the strap 608 in an open configuration. When the frame 628 is positioned within main body 621 and between the opposing side members 622, strap 608 is folded over the opening between the opposing side members 622 and coupled with the female coupling components 606. Reel assembly 602 may then be operated to tension the strap 608 and thereby compress or constrict the main body 621 and opposing side members 622 around frame 628 and thus, secure the bicycle atop the vehicle.

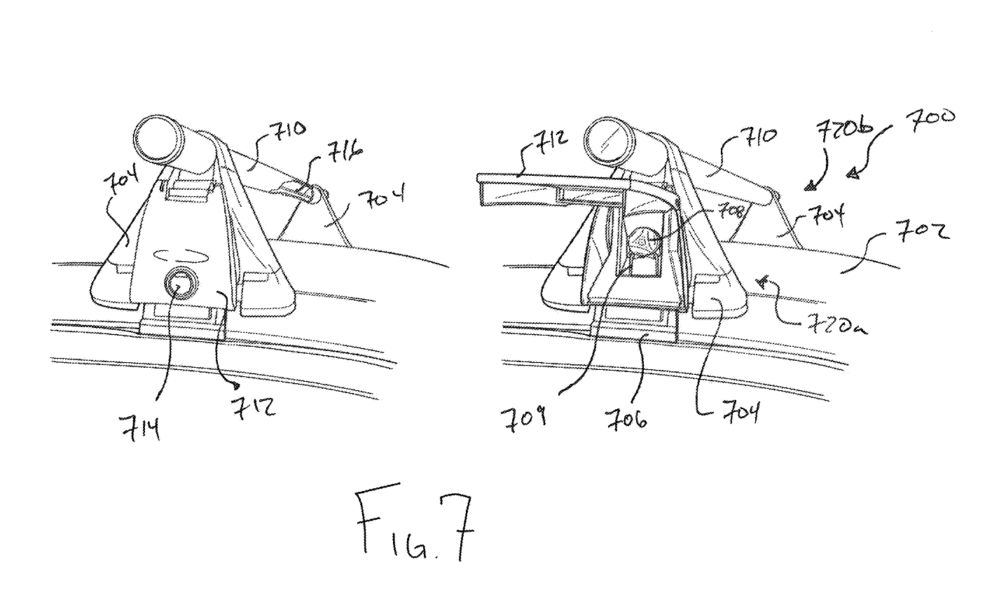

Referring now to FIG. 7, illustrated is a removable roof rack 700 that may be removably attached to a vehicle 702. Roof rack 700 includes opposing sides, 720a and 720b, and a rod or bar member 710 that extends longitudinally between the opposing sides, 720a and 720b. The opposing sides, 720a and 720b, are positioned and coupled with opposing sides of the vehicle 702. To couple the opposing sides, 720a and 720b, with the vehicle 702, the opposing sides, 720a and 720b, each include an attachment member 706 that is vertically extendable from the main body 704 of the opposing sides 720a and 720b. The attachment member 706 may include a hooked portion (not shown) that is positionable between the vehicle's frame and door to secure the respective opposing side, 720a or 720b, to the vehicle. The attachment member 706 may be extended downward from the main body 704 until the hooked portion (not shown) of attachment member 706 is positioned between the vehicle's frame and door. The attachment member 706 may then be retracted upward toward the main body 704 to firmly secure the respective opposing side, 720a or 720b, to the vehicle's frame. The same process is repeated on the opposite side of the car to firmly secure the other opposing side to the opposite side of the vehicle 702.

To extend and retract the attachment member 706 from an opposing side's 720a main body 704, the main body 704 includes a reel assembly 708 that is operable to tension lace 709. The lace 709 is attached to the attachment member 706 such that tensioning of the lace 709 causes the attachment member 706 to retract upward toward the main body 704. To extend the attachment member 706, main body 704 may include a spring or other biasing component (not shown) that biases the attachment member 706 toward the extended position. In other embodiments, a second lace (not shown) may be attached to the reel assembly 708 such that rotation of the reel assembly 708 in a first direction causes the attachment member to extend from main body 704 via the second lace, and rotation of the reel assembly 708 in a second direction opposite the first direction causes the attachment member 706 to retract toward the main body 704 via the first lace 709.

The opposite side 720b may similarly include a reel assembly (not shown), lace (not shown), and attachment device (not shown) that allow the opposite side 720b to be attached to the opposite side of the vehicle 702 as described above. The use of the reel assembly 708 enables the device 700 to be easily and conveniently attached to the vehicle 702. In some embodiments, the lace 709 (or a second lace) may extend through a lumen or channel 716 of rod 710 and may couple with an attachment member (not shown) of the opposite side 720b. This configuration allows both opposing sides, 720a and 720b, to be tensioned and firmly attached to the vehicle 702 through operation of a single reel assembly 708. In this manner, a user may position the attachment members 706 of the opposing sides, 720a and 720b, between the vehicle's frame and doors and then operate the single reel assembly 708 to securely attach the device 700 to the vehicle 702. This eliminates the need for the user to tension a single side (e.g., 720a) and then walk around the vehicle to tension the opposite side (e.g., 720b).

A cover 712 is pivotally coupled with the main body 704. The cover 712 is positioned to cover the reel assembly 708 after the reel assembly 708 is operated to firmly secure the device 700 to the vehicle 702. The cover 712 may be pivoted upward to allow a user to access the reel assembly 708 and subsequently pivoted downward to cover and secure the reel assembly 708. The cover 712 includes a lock 714 that allows the cover 712 to be locked to prevent access to the reel assembly 704, thereby discouraging or preventing theft or unwanted removal of the device 700. Cover 712 also prevents accidental opening or loosening of the attachment device due to incidental or other contact with reel assembly 708 as the vehicle is driven by a user.

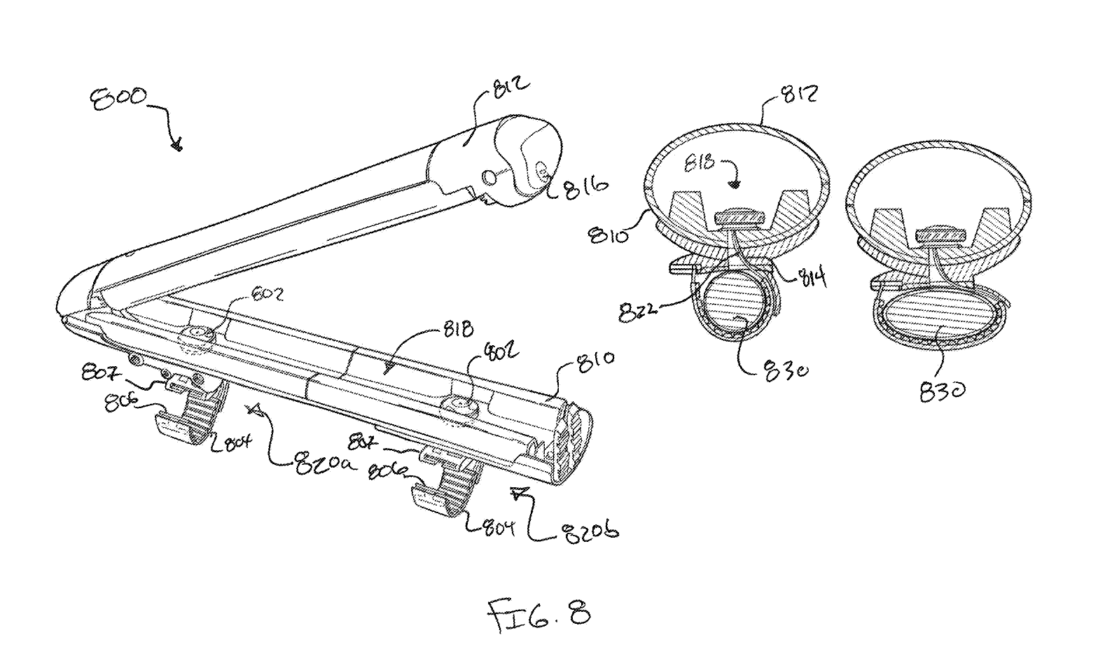

Referring now to FIG. 8, illustrated is a rack 800 that may be removably attached to a roof rack of the vehicle (not shown). Rack 800 is commonly used to transport outdoor gear, such as skis and snowboards. Rack 800 includes a main body 810 and a top member 812 that is pivotally coupled with main body 810 at a proximal end. Top member 812 may be pivoted upward to open rack 800 to allow the outdoor gear (e.g., skis, snowboards, and the like) to be inserted between the main body 810 and top member 812. The top member 812 may then be pivoted downward to secure the outdoor gear between the main body 810 and top member 812. Top member 812 includes a lock 816 that is used to secure the top member 812 to the bottom member 810 to prevent unwanted or accidental opening of the rack 800, such as during transportation of the outdoor gear.

To attach rack 800 to a vehicle's roof rack 830, rack 800 includes a pair of attachment mechanisms, 820a and 820b. The attachment mechanisms, 820a and 820b, may be similar to any of those described herein. For example, each attachment mechanism, 820a and 820b, includes a reel assembly 802 that is positioned within a channel 818 of main body 810. Each reel assembly 802 is coupled with lace 822 and each reel assembly 802 is operable to tension the lace as described herein. The lace 822 is disposed or inserted within a lumen or channel 814 of the main body 810. A distal end of the lace 822 is coupled with a strap 804 that is positionable around rack 830 of the vehicle. A distal end of the strap 804 includes an attachment mechanism 806 (e.g., a rod) that is couplable with a coupling device 807 (e.g., a pair of hooks or U-shaped channel) of main body 810 to secure the straps 804 around rack 830.

As described herein, an inner surface of each strap 804 may include a corrugated grippable material that grips the rack 830 while preventing scratching, scuffing, or other damage to the rack 830. The corrugated configuration of the inner strap surface also allows the strap 804 to be easily positioned and secured around various shaped racks 830. After the strap 804 is secured around the racks 830, the reel assembly 802 may be operated to tension the lace 822 and tighten or firmly secure the rack 830 to the vehicle's surface. Because the reel assemblies 802 are positioned within the channel 818 of main body 810, the reel assemblies are inaccessible to a user when the top member 812 is closed and/or locked with main body 810. As such, the reel assemblies 802 are protected from unwanted or accidental opening during transportation of the outdoor gear or otherwise.

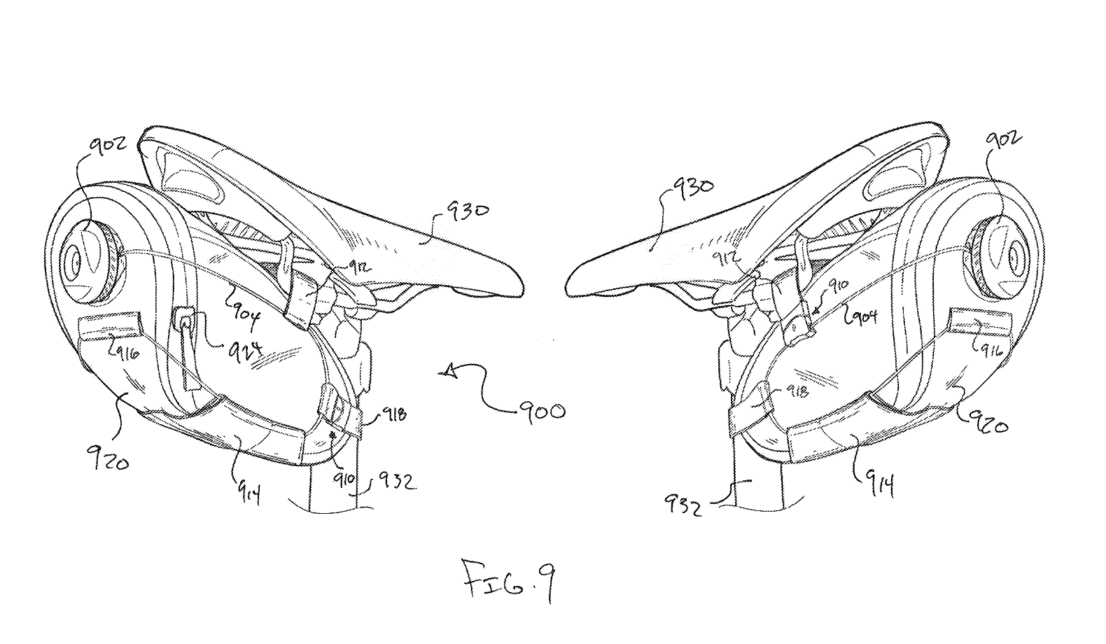

Referring now to FIG. 9, illustrated is an embodiment of a bag or pouch 900 that may be attached to a bicycle or other vehicle to transport one or more items. Bag 900 includes a bag body 920 having a reel assembly 902 that is operable to compress bag body 920. Reel assembly 902 is coupled with lace 904 that extends along a lace path around bag body 920 and through one or more lace guides. Bag body 920 also includes one or more straps that allow the bag body 920 to be attached to the bicycle and/or that function as lace guides for lace 904. For example, a first strap 912 may be inserted between frame members of the bicycle's seat 930. First strap 912 includes an attachment component 910, such as the male and female coupling components described herein, that allows the first strap 912 to be coupled to the frame members of the bicycle's seat 930. Bag body 920 also includes a second strap 918 that is positionable around a seat post 932 of the bicycle. Second strap 918 includes an attachment component 910 that allows the second strap 918 to be coupled or firmly attached to the seat post 932. The first strap 912 and second strap 918 also function as lace guides for the lace 904. For example, the attachment components 910 include a lumen through which the lace 904 is inserted, and an opposite end of the straps, 912 and 918, also include lumens or fabric loops through which the lace 904 is inserted.

Bag body 920 also includes a main strap 914 that is positioned on a bottom surface of bag body 920. Main strap 914 includes lumens or fabric loops through which the lace 904 is inserted such that main strap 914 also functions as a lace guide for lace 904. One or more additional lace guides 916 may be positioned elsewhere on bag body 920. Bag body 920 further includes a zipper mechanism 924, or other mechanism, that allows the bag body 920 to be opened so that one or more items may be positioned within an interior of bag body 920. In some embodiments, the reel assembly 902 and lace 904 may be used as the opening/closing mechanism for bag body 920 in addition to, or as an alternative to, compressing the bag body 920. In such embodiments, zipper mechanism 924 is not needed since the bag body 920 may be opened to access the bag's interior or closed to secure items placed within the bag's interior.

With the lace 904 extending along the lace path about bag body 920, reel assembly 902 may be operated to tension the lace 904 and compress or squeeze the bag body 920 together. Squeezing or compressing the bag body 920 may firmly secure the bag body 920 to the seat 930 and post 932, may protect or secure items positioned within bag body 920, and/or may prevent rocking or other movement or motion of bag body 920 as the bicycle is ridden by a user. The use of the reel assembly 902 and lace 904 allow the bag body 920 to be compressed or squeezed to a far greater degree than what is possible using conventional bicycle bags.

Having described the several embodiments, those skilled in the art will recognize that various other uses of the devices described herein are possible. Accordingly, the devices are not limited specifically to those embodiments described herein.

What is claimed is:

1. A device for coupling a component to a rack comprising:
a main body having a proximal end and a distal end that is releasably coupled with the proximal end, the main body being positionable around a body portion of the rack and the distal end being coupled with the proximal end to secure the main body to the body portion of the rack;
a tension member attached to the main body, the proximal end, or the distal end of the device; and
a tightening mechanism that is operably coupled with the tension member and configured to tension the tension member to shorten a longitudinal length of the main body and thereby constrict the main body about the rack to firmly secure the device to the rack.

2. The device of claim 1, wherein the main body includes a corrugated inner surface that facilitates in positioning the main body around the body portion of the rack.

3. The device of claim 1, wherein the main body includes a softened or compressible inner surface that compresses against the body portion of the rack as the main body is constricted about the rack.

4. The device of claim 1, wherein the proximal end includes a male coupling component and the distal end includes a female coupling component.

5. The device of claim 4, wherein the tightening mechanism is coupled with the proximal end.

6. The device of claim 1, wherein the device includes a second body that is attached to the main body and releasably attachable around the component to be coupled with the rack.

7. A method of coupling a device to a rack, the device being configured for attaching a component to the rack, the method comprising:
providing a device including:
a main body having a proximal end and a distal end;
a tension member attached to the main body, the proximal end, or the distal end of the device; and
a tightening mechanism that is operably coupled with the tension member and configured to tension the tension member;
positioning the main body around a body portion of the rack;
coupling the proximal end with the distal end to secure the main body to the body portion of the rack; and
tensioning the tension member, via the tightening mechanism, to shorten a longitudinal length of the main body and thereby constrict the main body about the rack to firmly secure the device to the rack.

8. The method of claim 7, wherein the main body includes a corrugated inner surface that facilitates in positioning the main body around the body portion of the rack.

9. The method of claim 7, wherein the main body includes a softened or compressible inner surface that compresses against the body portion of the rack as the main body is constricted about the rack.

10. The method of claim 7, wherein the proximal end includes a male coupling component and the distal end includes a female coupling component.

11. The method of claim 10, wherein the tightening mechanism is coupled with the proximal end.

12. The method of claim 7, wherein the device includes a second body that is attached to the main body and releasably attachable around the component to be coupled with the rack.
